(19) United States
(12) Patent Application Publication
(10) Pub. No.: US 2025/0298398 A1
(43) Pub. Date: Sep. 25, 2025

(54) INSTRUMENT AIR COMPRESSORS AUTO START LOGIC SYSTEM AND METHOD OF USE

(71) Applicant: SAUDI ARABIAN OIL COMPANY, Dhahran (SA)

(72) Inventor: Haider M. Tawil, Al Hofuf (SA)

(73) Assignee: SAUDI ARABIAN OIL COMPANY, Dhahran (SA)

(21) Appl. No.: 18/609,653

(22) Filed: Mar. 19, 2024

(51) Int. Cl. G05B 19/416

(52) U.S. Cl. CPC G05B 19/416; G05B 2219/41108

(57) ABSTRACT

A system includes an automatic computer-controlled management system and a compressed air system. The system includes a first standby compression generator pneumatically coupled to the compressed air system and coupled to the automatic computer-controlled management system. The system includes a second standby compression generator of a set of standby compression generators pneumatically coupled to the compressed air system and coupled to the automatic computer-controlled management system. The first standby compression generator is configured to transmit first standby compression generator data to the automatic computer-controlled management system and the second standby compression generator is configured to transmit second standby compression generator data to the automatic computer-controlled management system.

### BACKGROUND

Various industrial environments such as natural gas processing plants use compressed air as a utility service within the gas plant. The compressed air is provided by one or more air compressors that cycle on and off as, for example, compressed air pressure falls and rises due to rises and falls in compressed air demand. A stable air pressure is beneficial to the operation of the gas plant and a loss of air pressure may result in a shutdown of processes within the gas plant. Cycling the air compressors creates fluctuations in the pressure within the compressed air system and subjects the compressors to wear and tear. Compressed air management systems balance compressed air specifications with compressor duty cycles to provide predictable maintenance cycles.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

This disclosure presents, in accordance with one or more embodiments, a system including: an automatic computer-controlled management system disposed in an industrial environment and a compressed air system disposed in the industrial environment. The system includes a first standby compression generator pneumatically coupled to the compressed air system and coupled to the automatic computer-controlled management system. The first standby compression generator includes a first pressure transducer, a first timer, and a first loading sensor. The first pressure transducer, the first timer, and the first loading sensor are configured to generate first standby compression generator data. The first standby compression generator includes a first communication interface. The system includes a second standby compression generator of a set of standby compression generators pneumatically coupled to the compressed air system and coupled to the automatic computer-controlled management system. The second standby compression generator includes a second pressure transducer, a second timer, a second loading sensor. The second pressure transducer, the second timer, and the second loading sensor are configured to generate second standby compression generator data. The second standby compression generator includes a second communication interface. The system includes a data cable disposed in the industrial environment and coupled to the automatic computer-controlled management system, the first standby compression generator, and the second standby compression generator. The first standby compression generator is configured to transmit the first standby compression generator data to the automatic computer-controlled management system using the first communication interface. The second standby compression generator is configured to transmit the second standby compression generator data to the automatic computer-controlled management system using the second communication interface. The first standby compression generator and the second standby compression generator are separated by a predetermined distance within the compressed air system.

This disclosure presents, in accordance with one or more embodiments, an apparatus, including: a compression generator; a monitoring subsystem; a data cable connector configured to couple to a data cable; and a communication interface coupled to the data cable connector. The apparatus includes a processor coupled to the compression generator, the monitoring subsystem, and the communication interface. The apparatus includes a memory coupled to the processor, wherein the memory includes instructions configured to perform a method. The method steps include obtain a command to generate standby compression generator data, generate the standby compression generator data using the compression generator and the monitoring subsystem, and transmit the standby compression generator data over the data cable using the communication interface.

This disclosure presents, in accordance with one or more embodiments, a method including: monitoring, using an automatic computer-controlled management system, a set of operational parameters of a compressed air system operating in an industrial environment. The method includes recording, using the automatic computer-controlled management system, each operating value of a set of operating values corresponding to the set of operational parameters. The method includes comparing, using the automatic computer-controlled management system, each operating value of the set of operating values to each predetermined criterion of a set of predetermined criteria corresponding to the set of operational parameters. The method includes controlling, using the automatic computer-controlled management system, the compressed air system in response to a result of the comparing. Controlling the compressed air system includes: transmitting, by the automatic computer-controlled management system, a first command through a distributed control system to a first standby compression generator, pneumatically coupled to the compressed air system. Controlling the compressed air system includes transmitting, by the automatic computer-controlled management system, a second command through the distributed control system to a second standby compression generator of a set of standby compression generators, pneumatically coupled to the compressed air system. The first command and the second command are separated by a predetermined duration within the compressed air system. Controlling the compressed air system includes obtaining, by the automatic computer-controlled management system in response to transmitting the first command, first standby compression generator data from the first standby compression generator; and obtaining, by the automatic computer-controlled management system in response to transmitting the second command, second standby compression generator data from the second standby compression generator. The first standby compression generator data and the second standby compression generator data are generated using a plurality of pressure transducers to sense first pressure data, a plurality of timers to sense first timer data, and a plurality of loading sensors to determine first load data. The first standby compression generator data describes a first section of the compressed air system disposed in the industrial environment, and the second standby compression generator data describes a second section of the compressed air system that is different from the first section.

In light of the structure and functions described above, embodiments of the invention may include respective means adapted to carry out various steps and functions defined above in accordance with one or more aspects and any one of the embodiments of one or more aspect described herein.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1, 2, 3, 4A, 4B, 5, 6, and 7 show systems in accordance with one or more embodiments.

FIG. 8 shows a flowchart in accordance with one or more embodiments.

FIG. 9 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for monitoring compressed air pressure in one or more sections of a compressed air system, then automatically starting compressors in response to the monitoring. In particular, monitoring pressure may prove difficult in a compressed air system, especially when air compressors that are pneumatically coupled to the compressed air system are located remote from each other and near to or far from the demand point. Due to the compressible nature of compressed air combined with factors such as long air conduit lengths (e.g., pipes and hoses) and filters, dryers, and regulators in the compressed air path, the air pressure in one section of the system takes time to equalize with the pressures in various other sections. This results in problems, such as compressors detecting a local control signal to operate due to a local demand, thus operating out of phase with the commands from a master control system.

Examples of compressed air systems include pneumatic pipes in a facility, such as a gas plant, that deliver compressed air throughout the facility. Compressed air may be used, for example, to operate instrumentation. In that application, the compressed air is a utility termed instrument air and is provided by an instrument air supply. Instrument air compressors generate the instrument air supply. Industrial compressor examples include centrifugal compressors, screw compressors (oil-flooded and oil-free), rotary compressors, scroll compressors, and reciprocating compressors (piston and plunger.) Various compressors may be variable speed, while others operate by varying the load on the compressor. A centrifugal compressor, for example, may be in blow-off mode to reduce its output. The controls architecture of the system must be suited to properly match the compressed air system.

As compressed air systems grow in scale, more than one compressor may be added. Actively managing the operation of multiple compressors improves overall performance of the facility. One of the common management systems for sets of compressors such as a set of instrument air compressors is an auto start logic system named a sequencer. A compressor system manager such as the sequencer turns on and off the multiple compressors according to a predetermined start sequence (auto start) and/or a predetermined shut-down sequence (auto stop) according to operational factors. The computer-controlled sequencer may consider operational factors such as pressure (head), pressure drop, rate of pressure drop, run time duration, and others. The sequencer is engineered to generate only the minimum amount of compressed air to meet requirements. The sequencer set of instructions, i.e., a sequencer algorithm, may be integrated into each compressor, the DCS, and/or the compressed air system, and/or the system 300. The sequencer may follow several types of algorithms.

Past techniques to manage air compressors used sequencers identified by their algorithms, such as: cascade sequencer, target sequencer, flow-based sequencer, load-sharing sequencer, and base-trim sequencer. Using a communication cable (e.g., a data cable such as an optical fiber cable), the compressors may communicate standby compression generator data with gas plant equipment, such as the automatic computer-controlled management system. In some embodiments, a pressure log is generated from standby compression generator data. A pressure log may be a data record that is obtained using an automatic computer-controlled management system. Likewise, standby compression generator data may also be monitored continuously in real-time. The pressure logs may be used to form an array of past use. In some embodiments, standby compression generator data at different locations are combined to generate an array of past use and duty cycles to form a duty array of the compressed air system. In a duty array, compressor operational parameter measurements may be described as a function of pressure, run time, idle time, and loading. By collecting duty cycle data over time, changes to the compressor performance may be trended, simulated, and predicted, such as for maintenance, repair, and replacement operations. In this manner, a predicted duty cycling array may be formed by analyzing the duty arrays for the various compressors. Analysis of the arrays may prompt changes such as fine tuning to the hardware, firmware, software, and software configuration.

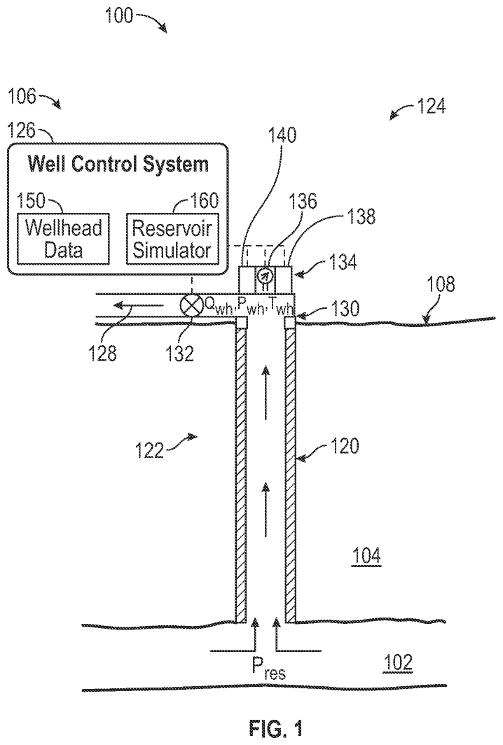

FIG. 1 shows a schematic diagram in accordance with one or more embodiments. As shown in FIG. 1, FIG. 1 illustrates a wellsite 100 that includes a hydrocarbon reservoir (e.g., reservoir 102) located in a subsurface hydrocarbon-bearing (e.g., formation 104) and a well system 106. The formation 104 may include a porous or fractured rock formation that resides underground, beneath the surface of the earth (e.g., surface 108). In the case of the well system 106 being a hydrocarbon well, the reservoir 102 may include a portion of the formation 104. The formation 104 and the reservoir 102 may include different layers of rock having varying characteristics, such as varying degrees of permeability, porosity, and resistivity. In the case of the well system 106 being operated as a production well, the well system 106 may facilitate the extraction of hydrocarbons from the reservoir 102.

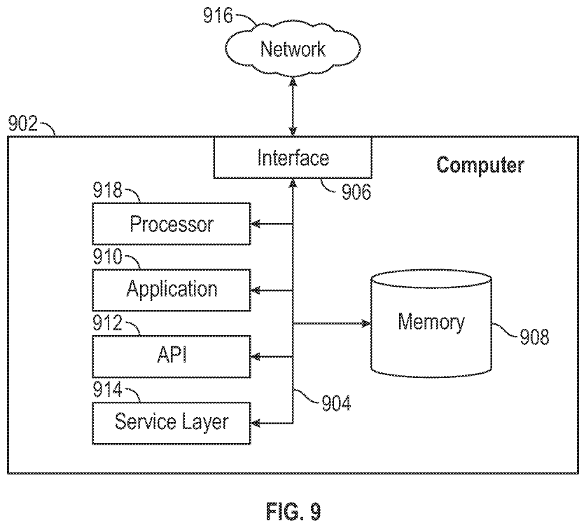

In some embodiments, the well system 106 includes a wellbore 120, a well sub-surface system 122, a well surface system 124, and a well control system 126. The well control system 126 may control various operations of the well system 106, such as well production operations, well completion operations, well maintenance operations, and reservoir monitoring, assessment, and development operations. In some embodiments, the well control system 126 includes a computer system that is the same as or similar to that of computer system (e.g., a computer 902) described below in FIG. 9 and the accompanying description.

The wellbore 120 may include a bored hole that extends from the surface 108 into a target zone of the formation 104, such as the reservoir 102. An upper end of the wellbore 120, terminating at or near the surface 108, may be referred to as the “up-hole” end of the wellbore 120, and a lower end of the wellbore, terminating in the formation 104, may be referred to as the “downhole” end of the wellbore 120. The wellbore 120 may facilitate the circulation of drilling fluids during drilling operations, the flow of hydrocarbon (e.g., oil and gas) production (e.g., production 128) from the reservoir 102 to the surface 108 during production operations, the injection of substances (e.g., water) into the formation 104 or the reservoir 102 during injection operations, or the communication of monitoring devices (e.g., logging tools) into the formation 104 or the reservoir 102 during monitoring operations (e.g., during in situ logging operations).

In some embodiments, during operation of the well system 106, the well control system 126 collects and records wellhead data 150 for the well system 106 and other data regarding downhole equipment and downhole sensors. The wellhead data 150 may include, for example, a record of measurements of wellhead pressure (P) (e.g., including flowing wellhead pressure (FWHP)), wellhead temperature (T) (e.g., including flowing wellhead temperature), wellhead production rate (Q) over some or all of the life of the well system 106, and water cut data. In some embodiments, the measurements are recorded in real-time, and are available for review or use within seconds, minutes, or hours of the condition being sensed (e.g., the measurements are available within 1 hour of the condition being sensed). In such an embodiment, the wellhead data 150 may be referred to as “real-time” wellhead data. Real-time wellhead data may enable an operator of the well system 106 to assess a relatively current state of the well system 106, and make real-time decisions regarding development of the well system 106 and the reservoir 102, such as on-demand adjustments in regulation of production flow from the well.

With respect to water cut data, the well system 106 may include one or more water cut sensors. For example, a water cut sensor may be hardware and/or software with functionality for determining the water content in oil, also referred to as “water cut.” Measurements from a water cut sensor may be referred to as water cut data and may describe the ratio of water produced from the wellbore 120 compared to the total volume of liquids produced from the wellbore 120. In some embodiments, a water-to-gas ratio (WGR) is determined using a multiphase flow meter. For example, a multiphase flow meter may use magnetic resonance information to determine the number of hydrogen atoms in a particular fluid flow. Because oil, gas and water all contain hydrogen atoms, a multiphase flow may be measured using magnetic resonance. In particular, a fluid may be magnetized and subsequently excited by radio frequency pulses. The hydrogen atoms may respond to the pulses and emit echoes that are subsequently recorded and analyzed by the multiphase flow meter.

In some embodiments, the well surface system 124 includes a wellhead 130. The wellhead 130 may include a rigid structure installed at the “up-hole” end of the wellbore 120, at or near where the wellbore 120 terminates at the surface 108. The wellhead 130 may include structures for supporting (or “hanging”) casing and production tubing extending into the wellbore 120. Production 128 may flow through the wellhead 130, after exiting the wellbore 120 and the well sub-surface system 122, including, for example, the casing and the production tubing. In some embodiments, the well surface system 124 includes flow regulating devices that are operable to control the flow of substances into and out of the wellbore 120. For example, the well surface system 124 may include one or more of a production valve 132 that are operable to control the flow of production 128. For example, a production valve 132 may be fully opened to enable unrestricted flow of production 128 from the wellbore 120, the production valve 132 may be partially opened to partially restrict (or “throttle”) the flow of production 128 from the wellbore 120, and production valve 132 may be fully closed to fully restrict (or “block”) the flow of production 128 from the wellbore 120, and through the well surface system 124.

Keeping with FIG. 1, in some embodiments, the well surface system 124 includes a surface sensing system 134. The surface sensing system 134 may include sensor devices for sensing characteristics of substances, including production 128, passing through or otherwise located in the well surface system 124. The characteristics may include, for example, pressure, temperature, and flow rate of production 128 flowing through the wellhead 130, or other conduits of the well surface system 124, after exiting the wellbore 120.

In some embodiments, the surface sensing system 134 includes a surface pressure sensor 136 operable to sense the pressure of production 128 flowing through the well surface system 124, after it exits the wellbore 120. The surface pressure sensor 136 may include, for example, a wellhead pressure sensor that senses a pressure of production 128 flowing through or otherwise located in the wellhead 130. In some embodiments, the surface sensing system 134 includes a surface temperature sensor 138 operable to sense the temperature of production 128 flowing through the well surface system 124, after it exits the wellbore 120. The surface temperature sensor 138 may include, for example, a wellhead temperature sensor that senses a temperature of production 128 flowing through or otherwise located in the wellhead 130, referred to as “wellhead temperature” (T). In some embodiments, the surface sensing system 134 includes a flow rate sensor 140 operable to sense the flow rate of production 128 flowing through the well surface system 124, after it exits the wellbore 120. The flow rate sensor 140 may include hardware that senses a flow rate of production 128 (Q) passing through the wellhead 130.

Referring still to FIG. 1, when completing a well, one or more well completion operations may be performed prior to delivering the well to the party responsible for production or injection. Well completion operations may include casing operations, cementing operations, perforating the well, gravel packing, directional drilling, hydraulic stimulation of a reservoir region, and/or installing a production tree or wellhead assembly at the wellbore 120. Likewise, well operations may include open-hole completions or cased-hole completions. For example, an open-hole completion may refer to a well that is drilled to the top of the hydrocarbon reservoir. Thus, the well may be cased at the top of the reservoir and left open at the bottom of a wellbore. In contrast, cased-hole completions may include running casing into a reservoir region.

In one well completion example, the sides of the wellbore 120 may require support, and thus casing may be inserted into the wellbore 120 to provide such support. After a well has been drilled, casing may ensure that the wellbore 120 does not close in upon itself, while also protecting the wellstream from outside contaminants, like water or sand. Likewise, if the formation is firm, casing may include a solid string of steel pipe that is run in the well and will remain that way during the life of the well. In some embodiments, the casing includes a wire screen liner that blocks loose sand from entering the wellbore 120.

In another well operation example, a space between the casing and the untreated sides of the wellbore 120 may be cemented to hold a casing in place. This well operation may include pumping cement slurry into the wellbore 120 to displace existing drilling fluid and fill in this space between the casing and the untreated sides of the wellbore 120. Cement slurry may include a mixture of various additives and cement. After the cement slurry is left to harden, cement may seal the wellbore 120 from non-hydrocarbons that attempt to enter the wellstream. In some embodiments, the cement slurry is forced through a lower end of the casing and into an annulus between the casing and a wall of the bored hole of the wellbore 120. More specifically, a cementing plug may be used for pushing the cement slurry from the casing. For example, the cementing plug may be a rubber plug used to separate cement slurry from other fluids, reducing contamination and maintaining predictable slurry performance. A displacement fluid, such as water, or an appropriately weighted drilling fluid, may be pumped into the casing above the cementing plug. This displacement fluid may be pressurized fluid that serves to urge the cementing plug downward through the casing to extrude the cement from the casing outlet and back up into the annulus.

Keeping with well operations, some embodiments include perforation operations. More specifically, a perforation operation may include perforating casing and cement at different locations in the wellbore 120 to enable hydrocarbons to enter a wellstream from the resulting holes. For example, some perforation operations include using a perforation gun at one or more reservoir levels to produce holed sections through the casing, cement, and sides of the wellbore 120. Hydrocarbons may then enter the wellstream through these holed sections. In some embodiments, perforation operations are performed using discharging jets or shaped explosive charges to penetrate the casing around the wellbore 120.

In another well completion, a filtration system may be installed in the wellbore 120 in order to prevent sand and other debris from entering the wellstream. For example, a gravel packing operation may be performed using a gravel-packing slurry of appropriately sized pieces of coarse sand or gravel. As such, the gravel-packing slurry may be pumped into the wellbore 120 between a slotted liner of a casing and the sides of the wellbore 120. The slotted liner and the gravel pack may filter sand and other debris that might have otherwise entered the wellstream with hydrocarbons. In another well completion, a wellhead assembly may be installed on the wellhead of the wellbore 120. A wellhead assembly may include a production tree (also called a Christmas tree) that includes valves, gauges, and other components to provide surface control of subsurface conditions of a well.

In some embodiments, a wellbore 120 includes one or more casing centralizers. For example, a casing centralizer may be a mechanical device that secures casing at various locations in a wellbore to prevent casing from contacting the walls of the wellbore. Thus, casing centralization may produce a continuous annular clearance around casing such that cement may be used to completely seal the casing to walls of the wellbore. Without casing centralization, a cementing operation may experience mud channeling and poor zonal isolation. Examples of casing centralizers may include bow-spring centralizers, rigid centralizers, semi-rigid centralizers, and mold-on centralizers. In particular, bow springs may be slightly larger than a particular wellbore in order to provide complete centralization in vertical or slightly deviated wells. On the other hand, rigid centralizers may be manufactured from solid steel bar or cast iron with a fixed blade height in order to fit a specific casing or hole size. Rigid centralizers may perform well even in deviated wellbores regardless of any particular side forces. Semi-rigid centralizers may be made of double crested bows and operate as a hybrid centralizer that includes features of both bow-spring and rigid centralizers. The spring characteristic of the bow-spring centralizers may allow the semi-rigid centralizers to compress in order to be disposed in tight spots in a wellbore. Mold-on centralizers may have blades made of carbon fiber ceramic material that can be applied directly to a casing surface.

In some embodiments, well intervention operations may also be performed at a well site. For example, well intervention operations may include various operations carried out by one or more service entities for an oil or gas well during its productive life (e.g., hydraulic fracturing operations, coiled tubing, flow back, separator, pumping, wellhead and production tree maintenance, slickline, braided line, coiled tubing, snubbing, workover, subsea well intervention, etc.). For example, well intervention activities may be similar to well completion operations, well delivery operations, and/or drilling operations in order to modify the state of a well or well geometry. In some embodiments, well intervention operations are used to provide well diagnostics, and/or manage the production of the well. With respect to service entities, a service entity may be a company or other actor that performs one or more types of oil field services, such as well operations, at a well site. For example, one or more service entities may be responsible for performing a cementing operation in the wellbore 120 prior to delivering the well to a producing entity.

Turning to the reservoir simulator 160, a reservoir simulator 160 may include hardware and/or software with functionality for performing a well simulation such as storing and analyzing well logs, production data, sensor data (e.g., from a wellhead, downhole sensor devices, or flow control devices), and/or other types of data to generate and/or update one or more geological models of one or more reservoir regions. Geological models may include geochemical or geomechanical models that describe structural relationships within a particular geological region. Likewise, a reservoir simulator 160 may also determine changes in reservoir pressure and other reservoir properties for a geological region of interest, e.g., in order to evaluate the health of a particular reservoir during the lifetime of one or more producing wells

While the reservoir simulator 160 is shown at a well site, in some embodiments, the reservoir simulator 160 or other components in FIG. 1 may be remote from a well site. In some embodiments, the reservoir simulator 160 is implemented as part of a software platform for the well control system 126. The software platform may obtain data acquired by a control system as inputs, which may include multiple data types from multiple sources. The software platform may aggregate the data from these systems in real time for rapid analysis. In some embodiments, the well control system 126 and the reservoir simulator 160, and/or a user device coupled to one of these systems may include a computer system that is similar to the computer system (e.g., computer 902) described below with regard to FIG. 9 and the accompanying description.

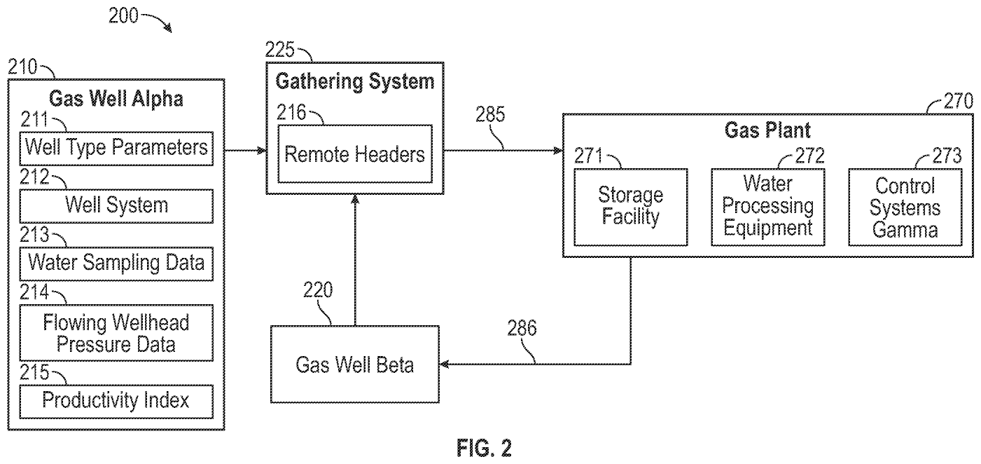

FIG. 2 shows a schematic diagram in accordance with one or more embodiments. As shown in FIG. 2, a gas production network (e.g., gas production network 200) may include various gas wells (e.g., gas well alpha 210, gas well beta 220), various gas plants (e.g., gas plant 270), various control systems (e.g., control systems gamma 273), various network elements (not shown), and/or a gas supply manager (not shown). A gas well may include a well system (e.g., well system 212) that is similar to well system 106 described above in FIG. 1 and the accompanying description. In some embodiments, various types of gas well data are collected over the gas production network, such as water sampling data (e.g., water sampling data 213), flowing wellhead pressure data (e.g., flowing wellhead pressure data 214), productivity index information (e.g., productivity index 215). Likewise, the gas production network may also collect various well type parameters (e.g., well type parameters 211) that describe various gas well characteristics, such as reservoir type, completion type, and surface facility conditions.

In some embodiments, one or more gas wells are coupled to a gathering system (e.g., gathering system 225). A gathering system (also referred to as a collecting system or gathering facility) may include various hardware arrangements that connect flowlines from several gas wells into a single gathering line. For example, a gathering system may include flowline networks, headers, pumping facilities, separators, emulsion treaters, compressors, dehydrators, tanks, valves, regulators, and/or associated equipment. In particular, a remote header (e.g., remote headers 216) may have production valves and testing valves to control a mixed stream for a flowline of a respective gas well. Thus, a gathering system may direct various hydrocarbon fluids to a processing or testing facility, such as a gas plant. In some embodiments, a gathering system manages individual fluid ratios (e.g., a particular gas-to-water ratio or condensate-to-gas ratio) as well as supply rates of oil, gas, and water. For example, a gathering system may assign a particular production value or ratio value to a particular gas well by opening and closing selected valves among the remote headers and using individual metering equipment or separators. Furthermore, a gathering system may be a radial system or a trunk line system. A radial system brings various flowlines to a single central header. In contrast, a trunk-line system uses several remote headers to collect oil and gas from fields that cover a large geographic area. Once collected, the gathering system may transport and control the flow of oil or gas to a storage facility, a gas processing plant, or a shipping point.

Referring still to FIG. 2, gas is transported from one or more gas wells (e.g., gas well alpha 210) to one or more gas plants (e.g., gas plant 270), such as through one or more mixed fluid streams (e.g., mixed fluid stream 285). More specifically, a gas plant may refer to various types of industrial plants such as a gas processing plant, a gas cycling plant, or a compressor plant. A gas processing plant (also referred to as a natural gas processing plant) is a facility that processes natural gas to recover natural gas liquids (e.g., condensate, natural gasoline, and liquefied petroleum gas) and sometimes other substances such as sulfur. A gas cycling plant may refer to an oilfield installation coupled to a gas-condensate reservoir. In particular, a gas cycling plant may extract various liquids from natural gas. Consequently, the remaining dry gas may be compressed prior to return to a producing formation, e.g., to maintain reservoir pressure. Moreover, various components of natural gas may be classified according to their vapor pressures, such as low-pressure liquid (i.e., condensate), intermediate pressure liquid (i.e., natural gasoline), and high-pressure liquid (i.e., liquefied petroleum gas). Examples of natural gas liquids include propane, butane, pentane, hexane, and heptane. A compressor plant is a facility that includes multiple compressors, auxiliary treatment equipment, and pipeline installations for pumping natural gas over long distances. A compressor station may also repressurize gas in large gas pipelines or to link offshore gas fields to their final terminals.

Keeping with gas plants, a gas plant may include water processing equipment (e.g., water processing equipment 272) that includes hardware and/or software for extracting, treating, and/or disposing of water associated with gas processing. More specifically, a gas plant may extract produced water (e.g., produced water 286) during the separation of oil or gas from a mixed fluid stream (e.g., mixed fluid stream 285) acquired from a gas well. This produced water is a kind of brackish and saline water brought to the surface from underground formations. In particular, oil and gas reservoirs may have water in addition to hydrocarbons in various zones underneath the hydrocarbons, and even in the same zone as the oil and gas. However, most produced water is of very poor quality and may include high levels of natural salts and minerals that have dissociated from geological formations in the target reservoir. Likewise, produced water may also acquire dissolved constituents from fracturing fluids (e.g., substances added to the fracturing fluid to help prevent pipe corrosion, minimize friction, and aid the fracking process). However, through various water treatments, produced water may be reused in one or more gas wells, e.g., through waterflooding where produced water is injected into the reservoirs. By injecting produced water into an injection well, the injected water may force oil and gas to one or more production wells.

Keeping with produced water, a gas plant may use various treatment technologies in order to reuse or dispose of produced water, such as conventional treatments and advanced treatments. For example, conventional treatments may include flocculation, coagulation, sedimentation, filtration, and lime softening water treatment processes. Thus, conventional treatment processes may include functionality for removing suspended solids, oil and grease, hardness compounds, and other nondissolved water components. With advanced treatment technologies, water processing equipment may include functionality for performing reverse osmosis membranes, thermal distillation, evaporation and/or crystallization processes. These advanced treatment technologies may treat dissolved solids, such as chlorides, salts, barium, strontium, and sometimes dissolved radionuclides. In some embodiments, produced water is sent to a wastewater treatment plant that is equipped to remove barium and strontium, e.g., using sulfate precipitation. Outside of treatments for reusing produced water, water processing equipment may dispose of produced water using various water management options. For example, produced water may be disposed in saltwater wells. Likewise, produced water may also be eliminated through a deep well injection.

In some embodiments, a gas plant may include one or more storage facilities (e.g., storage facility 271) and one or more of control systems (e.g., control systems gamma 273). For example, different forms of gas may be stored in various storage facilities that include surface containers as well as various underground reservoirs, such as depleted gas reservoirs, aquifer reservoirs and salt cavern reservoirs. With respect to control systems, a control system may include hardware and/or software that monitors and/or operates equipment, such as at a gas well or in a gas plant. Examples of control systems may include one or more of the following: an emergency shut down (ESD) system, a safety control system, a video management system (VMS), process analyzers, other industrial systems, etc. In particular, a control system may include a programmable logic controller that may control valve states, fluid levels, pipe pressures, warning alarms, pressure releases and/or various hardware components throughout a facility. Thus, a programmable logic controller may be a ruggedized computer system with functionality to withstand vibrations, extreme temperatures, wet conditions, and/or dusty conditions, such as those around a refinery or drilling rig.

With respect to distributed control systems, a distributed control system may be a computer system for managing various processes at a facility using multiple control loops. As such, a distributed control system may include various autonomous controllers (such as remote terminal units) positioned at different locations throughout the facility to manage operations and monitor processes. A distributed control system may include no single centralized computer for managing control loops and other operations. On the other hand, a SCADA system (supervisory control and data acquisition may include a control system that includes functionality for enabling monitoring and issuing of process commands through local control at a facility as well as remote control outside the facility. With respect to a remote terminal unit (RTU), an RTU may include hardware and/or software, such as a microprocessor, that connects sensors and/or actuators using network connections to perform various processes in the automation system.

Keeping with control systems, a control system may be coupled to facility equipment. Facility equipment may include various machinery such as one or more hardware components that may be monitored using one or more sensors. Examples of hardware components coupled to a control system may include crude oil preheaters, heat exchangers, pumps, valves, compressors, loading racks, and storage tanks among various other types of hardware components. Hardware components may also include various network elements or control elements for implementing control systems, such as switches, routers, hubs, PLCs, remote terminal units, user equipment, or any other technical components for performing specialized processes. Examples of sensors may include pressure sensors, torque sensors, rotary switches, weight sensors, position sensors, microswitches, hydrophones, accelerometers, etc. A gas supply manager, user devices, and network elements may be computer systems similar to the computer system (the computer 902) described in FIG. 9 and the accompanying description.

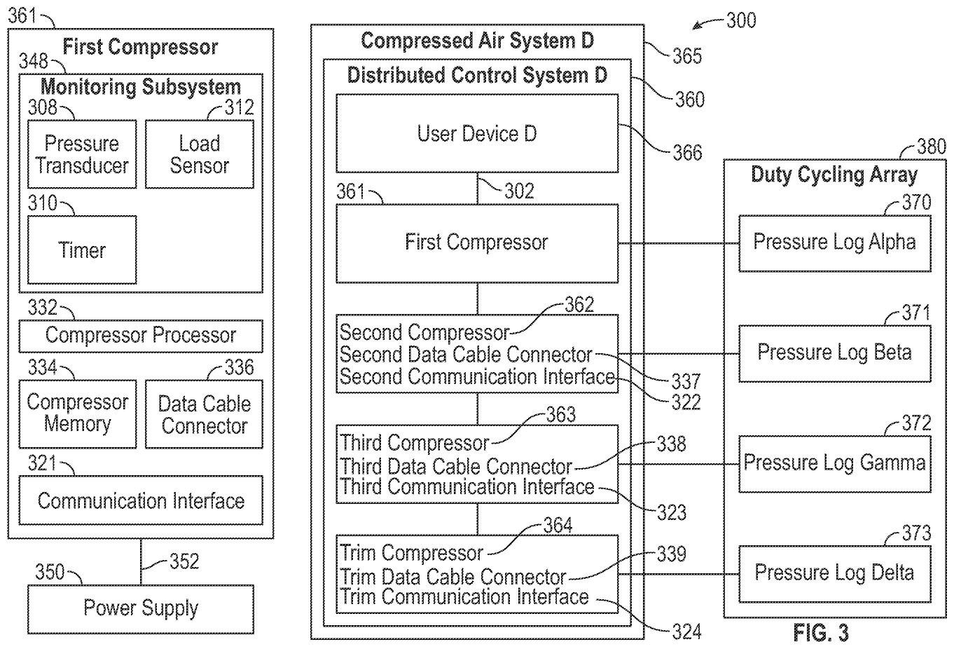

FIG. 3 shows a schematic diagram in accordance with one or more embodiments. As illustrated in FIG. 3, an automatic computer-controlled management system (a system 300) includes a distributed control system (e.g., a DCS D 360) disposed in an instrument air supply (e.g., a compressed air system D 365) disposed in an industrial environment. An industrial environment may include a plant such as a natural gas processing plant that is similar to a gas plant 270 described above in FIG. 2 and the accompanying description. The system also includes a first standby compression generator 361 coupled to the compressed air system. The first standby compression generator includes a first pressure transducer 308, a first timer 310, and a first loading sensor 312. The first pressure transducer, the first timer, and the first loading sensor generate first standby compression generator data. The first standby compression generator also includes a first communication interface 321 configured to communicate data from the first standby compression generator 361 to the DCS D 360, the compressed air system D 365, and the system 300.

The system also includes a second standby compression generator 362 coupled to the compressed air system. The second standby compression generator includes a second pressure transducer, a second timer, and a second loading sensor. The second pressure transducer, the second timer, and the second loading sensor generate second standby compression generator data. The second standby compression generator also includes a second communication interface 322 and a second data cable connector 337.

The system may also include a data cable 302 such as an optical fiber cable disposed in the gas plant and coupled to the distributed control system, the first standby compression generator, and the second standby compression generator. The first standby compression generator transmits the first standby compression generator data to the control system using the first communication interface. The second standby compression generator transmits the second standby compression generator data to the control system using the second communication interface. The first standby compression generator and the second standby compression generator may be separated by a predetermined distance within the gas plant. The data cable may be replaced by wireless communication such as, for example, radio, microwave, Bluetooth, or cellular communication.

As shown in FIG. 3, a user device D 366 may be included in the system 300. The user device may be used to input commands to the compressed air system and to receive data. The user device may be integrated in the system, for example by coupling to the data cable. The user device may couple to the system 300 by wireless communication such as, for example, radio, microwave, Bluetooth, or cellular communication. The user device may couple to the system through a network such as, for example, a local area network or wide area network.

In some embodiments, a user device may communicate with the system 300 to dynamically adjust a particular compression algorithm based on one or more user selections. The user device may be a personal computer, a handheld computer device such as a smartphone or personal digital assistant, or a human machine interface (HMI). For example, a user may interact with a user interface to change a target pressure band, a time interval of a compression period, or a compressor loading scenario. Through user selections or automation, the system 300 may maintain compressed air system performance and manage compressor wear.

The system 300 may automatically start and/or load the selected three standby compressors in a predetermined start sequence based on the operational parameters by presenting compressor performance, status, and associated information in a graphical user interface. As such, an automatically computer-controlled management system may provide agility and flexibility in determining and modifying compression algorithms. For example, the system 300 may start three compressors. In accordance with one or more embodiments the three compressors may be started sequentially, and/or the compressors may be started based on the compressor head pressure, and/or if one of a number of compressors trips (power to one or more compressors is interrupted). A timer and/or a pressure switch may be configured to delay starting of a compressor if, for example, a compressed air pressure is not measured to be below a predetermined criterion such as a “low setting 2.” Likewise, the system may automatically shut down and/or unload the selected three standby compressors in a predetermined shut-down sequence.

In some embodiments, a compression algorithm is generated by the system 300 upon obtaining a request from the user device and using various predetermined criteria such as pressure target bands, run duration ranges, and compression loading criteria. The request may be a network message transmitted between a user device and system 300 that identifies various sections of the compressed air system, a predetermined pressure target bands, run duration ranges, compression loading criteria, and other parameters for a requested compression algorithm. In some embodiments, the system 300 includes functionality for transmitting commands to one or more control systems, for example through the DCS, to implement a selected compression algorithm. For example, the system 300 may transmit a network message over a machine-to-machine protocol to the first standby compression generator 361, the second standby compression generator 362, a third standby compression generator 363, and a trim compressor 364 in compressed air system D 365. A command may be transmitted periodically, based on a user input, or automatically based on changes in compressed air generation data or compressed air demand data.

An automatic computer-controlled management system (e.g., system 300) may include one or more control systems (e.g., DCS D 360), various compressed air systems (e.g., compressed air system D 365), one or more communication cables (e.g., data cable 302), one or more standby compression generators (e.g., first standby compression generator 361, second standby compression generator 362, third standby compression generator 363, trim compressor 364). For example, a standby compression generator (e.g., first standby compression generator 361) may include a pressure transducer (e.g., first pressure transducer 308), a timer (e.g., first timer 310), a load sensor (e.g., first loading sensor 312), and a communication interface (e.g., first communication interface 321). In particular, a pressure transducer may record pressure within the compressed air system. Likewise, the timer may record a compressor run time corresponding with a duration that the compressor is running and/or loaded. The system may correspond a time of day and date of record parameters with the other logged data.

In some embodiments, a communication cable (e.g., data cable 302) is an industrial ethernet cable, a single-pair data cable, a multi-pair data cable, a signal cable, and/or a power cable. The data cable may be integrated with an electrical cable harness to connect some or all of the electrical components of the system. The harness may also be configured to transmit current, keep control over the system, and provide connection to a monitoring subsystem. The DCS D 360 is configured to allow data transfer through the data cable 302 from the compressed air system D 365 to the system 300.

In some embodiments, data cable 302 is an optical fiber cable that couples one or more control systems in a compressed air system to one or more standby compression generators in an industrial environment. Each optical fiber may be coated in a robust material, such as a plastic. Each optical fiber may be wound in a helix or other form with other optical fibers and/or with wires for electrical communication and/or for structural properties.

The optical fiber may be housed in a tube such as a stainless-steel tube suitable for the environment in which the optical fiber cable is installed, e.g., an industrial environment. The control system may transmit, over the optical fiber cable, a command to one or more standby compression generators. Likewise, a standby compression generator system may collect standby compression generator data using a network protocol over the same or a different communication cable. As such, network messages may be transmitted between a control system and standby compression generators using various communication interfaces.

Referring still to FIG. 3, in some embodiments, one or more of the standby compression generators include a processor (e.g., processor 332), a memory (e.g., memory 334), and an optical fiber connector or data cable connector (e.g., a data cable connector 336) that couples to data cable 302. The first communication interface 321 may be coupled to the data cable connector 336 and configured to transmit to a control system the standby compression generator data regarding a compressed air pressure of interest in a compressed air system D 365. A compressed air area of interest may be an instrument air supply. The third standby compression generator 363 also includes a third communication interface 323 and a third data cable connector 338. The trim compressor 364 also includes a trim communication interface 324 and a trim data cable connector 339.

A standby compression generator may include the monitoring subsystem (e.g., monitoring subsystem 348). The monitoring subsystem may monitor the various pressures, temperatures, run time durations, compressor loading, electrical current and voltage, and flow rates of the compressor, the intake air, and the output air. The monitoring subsystem may comprise, for example, pressure transducers, timers, and loading sensors. The sensors of the monitoring subsystem configured to measure, for example, compressed air output pressure, compressor run time duration, and compressor loading percentage.

The DCS may cooperate with the monitoring subsystem to control the compressor. The DCS may use a power supply 350 in combination with the monitoring subsystem to control operation of the compressor (e.g., first standby compression generator 361) through a wiring harness 352. The monitoring subsystem may include a display showing all the system parameters, monitored parameters, and a set of operational parameters such as pressure, temperature, and flowrate parameters. The display may also show limit alarm trips and program interlocks, e.g., permissives. The display may be integrated in the DCS such as in a control panel. The control panel may be used as an interface between an operator and the system 300.

Monitoring compressor operating parameters may include monitoring for excessive conditions such as pressures, temperatures, and loadings that might impact the integrity of the compressor, the DCS, the compressed air system, or other components of the system 300. For example, electrical power may be monitored and quantified as a percentage fully loaded power consumption rating, i.e., percent of full load rating, of each compressor. Monitoring percent full load provides the data to log the loading balance between compressors. A log of percent full load for four compressors results in values such as first compressor 80%, second compressor 78%, third compressor 82%, and trim compressor 92%. The logged data may be logged over time to form a duty array.

The logged data pressure may be used to form a pressure log for each compressor. FIG. 3 shows that pressure data from first standby compression generator 361 may be used to form a pressure log alpha 370. Pressure data from the second standby compression generator 362 may be used to form a pressure log beta 371. Pressure data from third standby compression generator 363 may be used to form a pressure log gamma 372. Pressure data from trim compressor 364 may be used to form a pressure log delta 373. The pressure logs for the compressors may be combined to form a duty cycling array 380.

The logged data for more than one compressor and for various durations may be combined to form the duty cycling array. The duty cycling arrays may be analyzed to form a predicted duty cycling array. For example, standby compression generator data, pressure data, timer data, and load data may be used to perform a compression simulation of the compressed air system, a predetermined section of the compressed air system, or the industrial environment. The compression simulation may form the predicted duty cycling array. For example, first standby compression generator data, first pressure data, first timer data, and first loading data may be used to perform a compression simulation of a first section of an instrument air system in a gas plant.

Analysis of the duty cycling array and performing compression simulations may result in the automatic computer-controlled management system (e.g., system 300) adjusting one or more operational parameters of the compression operation. For example, the system may adjust the rate at which a pressurization operation occurs. The system may load a compressor at a lower or higher rate to meet operational parameters in response to results from the compression simulations.

The various operational parameters may be monitored for one, some, or all compressors providing instrument air supply in an industrial environment such as a gas plant. In particular, a high level, e.g., a level near or exceeding a limit, of an operational parameter, such as compressed pressure data, in one or more compressed air systems may require a compressor maintenance operation. For example, the compression maintenance operation may include a change to the hardware, firmware, software, or software configuration to balance the operational parameter(s) of the one or more compressed air systems. Implementation of monitoring may also allow continually monitoring the compressed air system to determine the degree or magnitude of use and wear. Thus, compressed air system monitoring may be used to make decisions regarding a compressed air system.

Referring still to FIG. 3, in some embodiments, a control system may determine a compressed air pressure of a predetermined section of an industrial environment using pressure sensor data. For example, a control system may determine whether the compressed air pressure of the predetermined section of the industrial environment satisfies a predetermined criterion. The control system may terminate a compression operation at the compressor in response to determining that the compressed air pressure fails to satisfy the predetermined criterion.

In some embodiments, a predetermined criterion corresponds to a compressed air pressure falling below a satisfactory threshold, such as for operation or safety of an industrial operation. In particular, the predetermined criterion may be a predetermined difference between a compressed air pressure specification required by an industrial operation and the current compressed air pressure determined by a pressure sensing system. For example, an industrial operation may require a pressure of 100 psi (pounds per square inch), a determined pressure may be 75 psi, and therefore a pressure drop may be 25 psi. The predetermined criterion may be a compressed air pressure drop maximum of 20 psi or a compressed air pressure of 80 psi.

In this example the pressure difference of 25 psi of the predetermined section of the industrial environment fails to satisfy the predetermined criterion of a compressed air pressure loss maximum of 20 psi or a compressed air pressure of 80 psi. In this case the control system may adjust one or more compression parameters of the compression operation. Examples of adjusting compression parameters may include adjusting the compression rate, the compression pressure, the compression run time duration, compressor start delay duration and/or schedule, and terminating the compression operation.

An apparatus may include a compression generator, a monitoring subsystem, a data cable connector to couple to a data cable. The apparatus may include a communication interface coupled to the data cable connector. The apparatus may include a processor coupled to the compression generator, the monitoring subsystem, and the communication interface. The apparatus may include a memory coupled to the processor. The memory may have in instructions to perform a method to obtain a command to generate standby compression generator data. The data may be generated using the compression generator and the monitoring subsystem. The method may include instructions to transmit the standby compression generator data over the data cable using the communication interface.

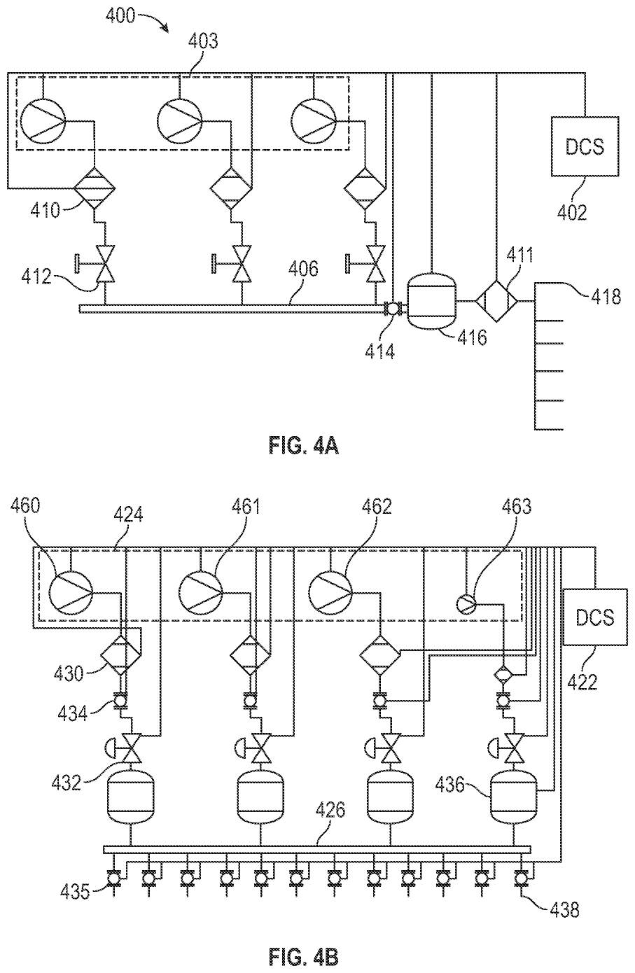

FIGS. 4A-4B show a compressed air system layout 400 in two configurations. In FIG. 4A, a piping and instrumentation diagram with a set of three air compressors (e.g., a set of compressors gamma 403) are shown pneumatically coupled to a header 406. FIG. 4A shows a DCS E 402 in communication with each compressor of the set of compressors. For each compressor, an air dryer (e.g., air dryer 410) and a manual valve (e.g., valve 412) are disposed between and pneumatically coupled to the compressors and the header. A flowmeter (e.g., a flowmeter 414), a receiver tank (e.g., receiver 416), and another air dryer (e.g., air dryer 411) are shown disposed between the header and the pneumatic plumbing providing compressed air taps (e.g., a tap 418) to the applications. The DCS E 402 also communicates to and from each instrument. Instruments may include a pressure gauge on the compressor output, a pressure differential sensor measuring pressure differential between the input and the output of the air dryer, a valve position sensor, a moisture detection sensor, a moisture liquid level sensor, and other sensors known in the art.

FIG. 4B shows four compressors in a set of compressors (e.g., a set of compressors delta 424) pneumatically coupled to a header 426. The set of compressors beta may include a first standby compression generator 460, a second standby compression generator 461, a third standby compression generator 462, and a trim compressor 463. FIG. 4B shows a DCS F 422 in communication with each compressor of the set of compressors. For each compressor, an air dryer (e.g., air dryer 430), an actuated valve (e.g., valve 432), a flowmeter (e.g., flowmeter 434), and a receiver tank (e.g., receiver 436) are disposed between and pneumatically coupled to the compressors and the header. A flowmeter (e.g., flowmeter 435) is shown disposed between and pneumatically coupled to the header and the pneumatic plumbing providing compressed air taps (e.g., a tap 438) to the applications. The DCS F 422 also communicates to and from each instrument. Instruments may include a pressure gauge on the compressor output, a pressure differential sensor measuring pressure differential between the input and the output of the air dryer, a moisture detection sensor, a moisture liquid level sensor, and other sensors known in the art.

Returning to FIG. 3, one or more control systems may include hardware and/or software for collecting sensor data and equipment data from the various compression generators. For example, a control system may include one or more programmable logic controllers (PLCs) that include hardware and/or software with functionality to control one or more processes performed by a compression sensing system. A programmable logic controller (PLC) may be a ruggedized computer system with functionality to withstand vibrations, extreme temperatures, wet conditions, and/or dusty conditions, for example, around an industrial environment or industrial site. In some embodiments, the control system includes functionality for controlling one or more compression operations for a compressed air system. For example, a programmable logic controller may control valve states, fluid levels, pipe pressures, warning alarms, and/or pressure releases throughout compressed air system equipment. Without loss of generality, the term control system may refer to a compression operation control system that is used to operate and control compression equipment, a data acquisition control system that is used to acquire compression data and/or sensor data to monitor compression operations, or a compressed air system interpretation software system that is used to analyze and understand compression events, pressure logs, and compression progress. In some embodiments, the DCS D 360 may include a computer system that is similar to the computer system (e.g., computer 902) and/or the well control system 126 described with respect to FIGS. 1 and 9 and the accompanying description, respectively.

Pressure sensors are coupled to the compressed air system to monitor and/or record the header pressure data. Compression generators such as air compressors (e.g., a compressor) are controlled through and/or by the DCS. The DCS has a feedback loop that will operate the compressor in response to a comparison between an operating value and an operating criterion. The operating value may be part of a set of operating values and the operating criterion may be part of the set of operational parameters of the compressed air system.

For example, the DCS may turn off the compressor when an operating value such as a current header pressure as measured in the header (header pressure data) satisfies an operating criterion such as a target header pressure minimum. In like manner, the DCS may turn on the compressor when the current header pressure fails to satisfy the target header pressure minimum. Set points, such as the target header pressure minimum, are displayed on and may be adjusted using a user device such as a control panel of an operator workstation disposed in the system.

The DCS operator uses a control panel with a graphic user interface (GUI) to a control system software to configure the software with operational limitations by entering the operational parameters and the operational criteria. In this manner, the operational limitations, i.e., the operational criteria, are based on an input from a user device. Using the GUI, the user may designate certain compressors in a set of compressors as standby compressors.

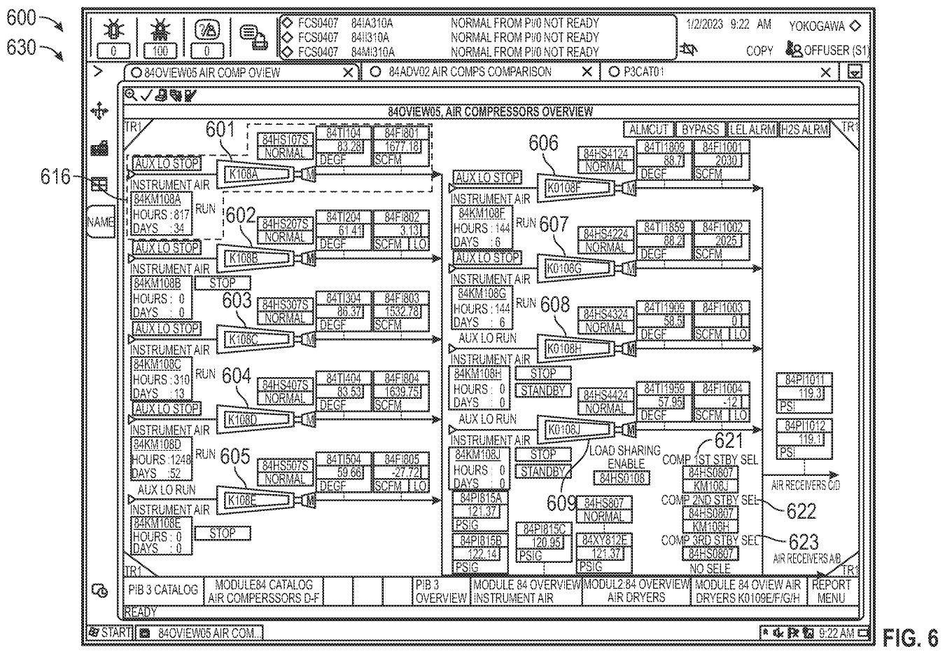

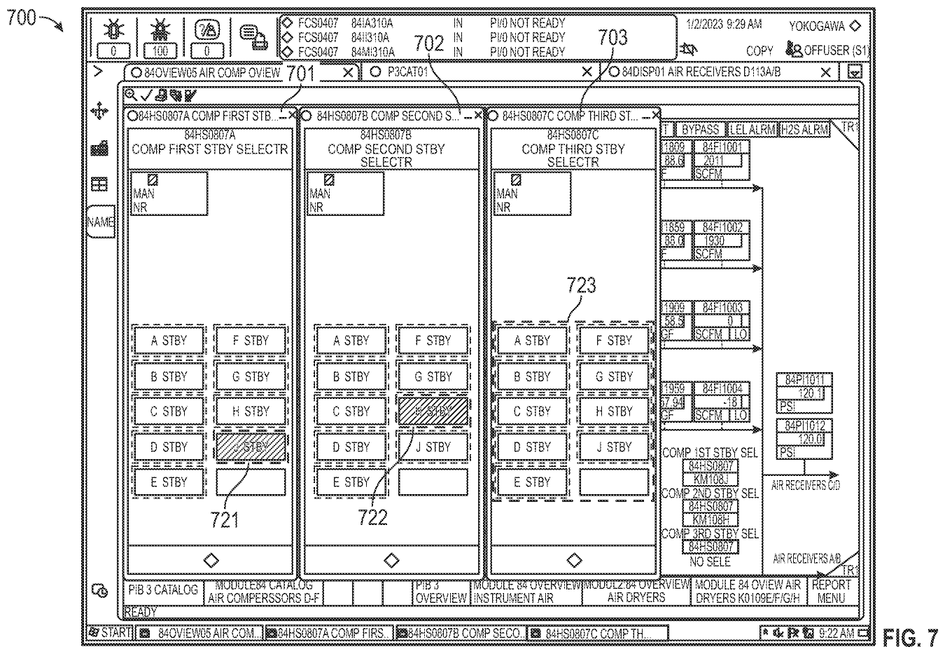

An example of a graphical user interface is illustrated in FIG. 6 and FIG. 7. FIG. 6 shows an example overview GUI 600 and FIG. 7 shows an example of a DCS face plate GUI (e.g., a GUI 700) in accordance with one or more embodiments.

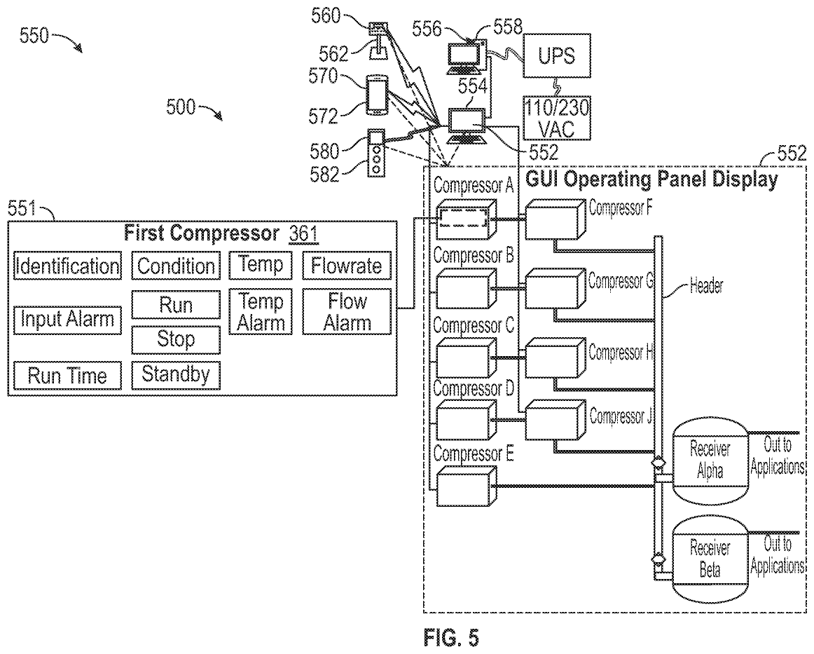

FIG. 5 shows a schematic of a graphical user interface (e.g., a GUI 500). GUI 500 may reflect an overview GUI of the compressed air system. Automatic computer-controlled management system (e.g., a system 550) may include the GUI 500 within a display (e.g., a display 552) of a control panel (e.g., a control panel A 554) coupled to a processor (e.g., a processor 556) within a computer system (e.g., a computer system 558). System 550 may include a control panel (e.g., a control panel B 560) integrated with a pedestal stand (e.g., a pedestal B 562). System 550 may include a control panel C 570 integrated with a user device (e.g., user device C 572). System 550 may include a control panel (e.g., control panel D 580) integrated with a hand-held controller such as a pendant (e.g., pendant D 582). The control panel B 560, the control panel C 570, and the control panel D 580 may couple to other components of the system 550 using wired and/or wireless communication. For example, a data cable may be used, or wireless communication may be used. Wireless communication may include, for example, radio, microwave, Bluetooth, or cellular communication.

The DCS may include various modes, statuses, and states. Modes may be configurations to the software that have a set of instructions corresponding to a plan for controlling the hardware such as compressors, valves, air dryers, and receivers. Statuses may include information that the DCS has taken from the plan and/or from the DCS operator and has assigned to the individual portions of the DCS configuration for the hardware. States include the real-time state of the hardware as transmitted back to the DCS.

The DCS operator may enter various modes of operation for the set of instrument air compressors. An auto-start mode may include a compressor being ready to activate upon obtaining a command to start. A remote mode of operation allows the automatic computer-controlled management system to operate the compressor remotely using the control panel. A local mode of operation may include granting control of one or more compressors to a local operator. Local mode for a compressor allows an operator to control the compressor set to local mode by performing inputs to the compressor without using the automatic computer-controlled management system. A manual mode of operation may include one or more of the compressors being activated/deactivated and/or loaded/unloaded according to manual inputs (e.g., manual-start) to the compressor through the GUI.

A maintenance mode may indicate a compressor out of service for maintenance. An out of service mode (e.g., an OOS mode) may indicate a compressor is not available to the automatic computer-controlled management system. An OOS mode may indicate that the compressor is offline such as when it has been completely disconnected and/or removed from the compressed air system. The OOS mode is manually done by the DCS operator if the air compressor is undergoing maintenance activity to prevent auto-start or manual-start of the air compressor. An in-service mode may indicate a compressor is generally ready for activation. An in-service mode may indicate that the compressor is online.

The DCS operator may enter an auto start and auto stop, automatic management mode (a system auto mode or auto-start) by inputting an algorithm for the set of compressors, the standby compressors, or the entire compressed air system. The DCS operator may input the algorithm using a user device, the GUI 500 on the display of the control panel, the control panel itself, or other terminal coupled to the system. The compressor that the operator selects for standby duty is termed a targeted standby compressor. The targeted standby compressor is placed in an Auto-Start condition (e.g., a compressor set to the auto-start mode.)

The automatic computer-controlled management system may include the capability to communicate the data to the user device. For example, the system may communicate the set of operating values of the set of operational parameters. For example, the system may communicate header pressure data such as header pressure drop, compressor trip status, or compressor load state.

In operation, each compressor of a set of compressors will have an operational state and a readiness status. Operational states may include, for example, running-loaded, running-unloaded, etc. Readiness statuses may include active/ready-to-start, out-of-service, running, stopped, standby, and offline.

The running status may include a running-loaded operational state. For example, a running status for a compressor may have a running-loaded operational state of 30%, 50%, 75%, or 100% load. The running-loaded operational state may have any value in the range of 0% to 100% load.

The running status may include a running-overloaded operational state wherein the compressor has a load exceeding 100%, for example a running-overloaded operational state of 103% or 115% load.

The running status may include a running-vacuum operational state wherein the compressor has a load with a negative value such as a running-vacuum operational state of −3% or −10% load.

An operational state may include a trip state. A tripped operational state may indicate that power to the compressor has been interrupted or tripped. For example, power may be interrupted, if a circuit breaker or a thermal overload breaker providing power to the compressor opened or tripped. For example, the circuit breaker may trip, if an electrical fault is detected. Other faults may cause a trip. For example, an overload condition, an overheat condition, or a safety guard breach may cause a fault. Power may be interrupted is a permissive conditions fail to be met and an alarm may be sent to a control panel of the system to alert the fault.

A compressor in Auto-Start mode may start automatically upon obtaining a command to start or activate. A command to start may be sent by a control system. The determination to start may derive from a calculation performed by a processor. The processor may include a set of instructions to carry out the algorithm entered by the operator. The calculation may be, for example, comparing a pressure measurement such as a header pressure in a predetermined section, with a predetermined criterion or criteria such as a pressure range. A pressure range may be, for example, a target pressure range. The set of instructions for the processor may include calculating the difference between the measured pressure and the target pressure. Upon determining a result of the comparison, the processor may take an action. An action may include starting and/or loading a compressor by sending a start/load command to the compressor through the system, the compressed air system, the DCS, and/or the user device. Upon obtaining the command to start, the compression generator may begin a pressurization operation such as an air compression operation by turning on, starting, and/or loading an air compressor.

The system stores the operational record of the standby compression generator data, e.g., the data values that for the pressure log and that comprise the array. The operational record may be reported, for example, to a notification center and may further be reported by an alert and an advisory to a notification center and/or one or more concerned entities (e.g., the operator and/or a technician), as desired. The report may comprise an alarm sent to the control panel. The alarm may reflect, for example, that the result of the comparing of current status (each operating value of the set of operating values) fails to satisfy a predetermined criterion.

The system may include lockouts and overrides in accordance with one or more embodiments. The DCS operator will be able to select a compressor to be in standby duty. The compressor that the operator selects for standby duty is termed the targeted standby compressor. The DCS may integrate readiness statuses from the monitoring subsystem. The system is configured with conditions of satisfaction (permissives) under which the lockouts permit the system to run. A status of ready to start (RTS) may indicate that the conditions of satisfaction monitored by the permissives have been met. The permissives may include values or value ranges of various operational parameters. The conditions need to be met (satisfying the conditions needs to be achieved) before the lockout unlocks the system. The operator will be able to select the targeted standby compressor only after all the conditions are satisfied.

For example, a permissive may include compressor temperature falling within a value range. The operational parameter is temperature. The operational value is a temperature value such as 82° F. (28° C.). The operational parameter permissive range may be −40° F. (−40° C.) to 200° F. (+93° C.). In this case the conditions of satisfaction are met because 82° F. falls within the range of −40° F. to 200° F. Other examples of permissives include various modes such as active/ready-to-start (e.g., active RTS); confirm remote mode, affirm not local mode, affirm not maintenance mode, affirm not out-of-service mode (e.g., OOS.) Operational parameters that may be monitored by the permissives may include, for example, header pressure, header pressure drop, header pressure drop rate, running state, not running state, trip state, running-loaded state, running-unloaded state, running-loaded percentage, running-pressure build-up rate, running-duration compared with predetermined parameters such as a header pressure increase, a header pressure decrease, or no-change to header pressure.

The system will continue to monitor the conditions to ensure that the lockout conditions remain satisfied after the selection. The system will automatically deselect the compressor in the event of losing one of the permissives for Auto-Start selection. Furthermore, the system will activate the alarm and send the alarm to alert an operational parameter (such as a temperature too high of an identified compressor) about it to the DCS operator.

Various algorithms may be input to the control system. An algorithm performs an automatic compression management method based on an input from the user device. For example, the DCS operator may input a predetermined sequence using a cascade sequencer algorithm.

### Cascade Sequencer Algorithm

A cascade sequencer algorithm performs sequential starting and/or loading of compressors based on falling pressure, and the reverse for rising pressure. As pressure drops, a first standby compressor (e.g., a first on compressor) starts and loads, and if pressure drops further, then a second standby compressor (e.g., a next on compressor) starts and loads. If pressure continues to drop, then a third standby compressor (e.g., a last on compressor) starts and loads. The sequence reverses as the pressure rises. The last on will load and unload once the number of compressors running stabilizes. The sequencer algorithm may change the order around to even out wear. For example, the last on compressor may become the first on or the next on compressor during a subsequent pressurization cycle. In this manner the system may send the first activation command, the second activation command, and the third activation command in a predetermined sequence.

### Target Sequencer Algorithm

The DCS operator may input a predetermined start sequence using a target sequencer algorithm. A target sequencer algorithm performs sequential starting and/or loading of compressors based on falling pressure and includes a trim compressor. The target sequencer algorithm may use a trim compressor pressure band (trim band) for activating/deactivating the trim compressor. The target sequencer algorithm may use a base-load pressure band (base band) for activating/deactivating base-load compressors. The trim band may be specified to a pressure range that is different from the base band. In particular, the trim band may be narrower than the base band. For instance, the trim band pressures may range from 100 psi (pounds per square inch) to 125 psi, whereas the base band pressures may range from 90 psi to 120 psi.

The target sequencer manages the number of base-load compressors running without having to wait for pressure to continue to drop again. The first time the pressure drops to the lower end of the base-load point, e.g., the low end of the base-load pressure band, the trim compressor is already fully-loaded, and a first standby base compressor activates.

Using the target sequencer algorithm, the second time the pressure drops to the same lower end of the base-load point, a second standby base compressor activates. The subsequent compressors are activated in like manner. The sequence reverses at the high limit of the wider pressure band, but in reverse. The first time the pressure rises to the top end of the base-load point, e.g., the top end of the base-load pressure band, the first standby base compressor deactivates. The subsequent compressors are deactivated in like manner.

The target sequencer algorithm may use timers to determine duration targets, rather than pressure targets. For example, the first time the pressure drops to the lower end of the base-load point, e.g., the low end of the base-load pressure band, the trim compressor is already fully-loaded, and a first standby base compressor activates and a timer starts. The use of timers may be utilized to determine if a next on compressor needs to start.

For example, the determination that a second standby base compressor should start may be based upon the run time of the first standby base compressor reaching a predetermined duration, and system pressure not reaching the target pressure. Under those conditions then a second standby base compressor activates. The subsequent compressors are activated in like manner. The use of timers may permit a smaller range pressure band to meet compressed air application specifications instead of the wider pressure band to determine if the next compressor needs to start, thus target sequencers may offer a narrower operating pressure differential.

### Flow-Based Algorithm

The DCS operator may input a predetermined sequence using a flow-based algorithm. A flow-based sequencer algorithm performs sequential starting and/or loading of compressors based on total flow. Using the computer processor, the flow-based sequencer may determine a quantity and size of base-load compressors to activate based on total flow of compressed air, i.e., compressed air demand, rather than a predetermined sequential order. Using the flow-based sequencer may offer a broader operating flowrate range.

### Load-Sharing Algorithm

The DCS operator may input a predetermined start sequence using a load-sharing algorithm. A load-sharing sequencer algorithm performs sequential starting and/or loading of compressors based on total load. Using the computer processor, the load-sharing sequencer may determine a uniform pressure and uniform percent load for a set of compressorss. For example, the load-sharing sequencer may activate multiple proportional compressors at the same pressure target and with the same percent load. The automatic computer-controlled management system continuously revises the operating status of each compressor of the set of compressors. The load-sharing algorithm may expand the effective range of efficient trim operation and thereby provide compressed air system stability and reduce compressed air waste.

### Base-Trim Algorithm

The DCS operator may input a predetermined start sequence using a base-trim algorithm. A base-trim sequencer algorithm performs sequential starting and/or loading of compressors based on differing algorithms for the trim compressor(s) than the algorithm used for the based-load compressors. For example, the trim compressor may utilize a cascade algorithm or a target algorithm. Furthermore, the trim compressor may operate at an elevated pressure exceeding the broader pressure rating of the compressed air system. The trim compressor elevated pressure may be regulated by a pressure-flow controller. In contrast, the base-load compressors may be controlled by a target algorithm or a cascade algorithm but different than the trim compressor algorithm. The base-load compressors may have their operating parameters correspond with the broader compressed air system. For example, the base-load compressors may run at a lower pressure than the trim compressors.

The compression generator data values may be used to determine a predicted duty cycling array. The duty cycling array may be known as a compressor use profile. Examples of data that comprise the compressor use profile include the following: Unit number (e.g., a compressor identification such as unique number, a process flow diagram tag number or code, a piping and instrumentation diagram tag, and/or a compressor serial number); operating outlet psi; hours and minutes duration run time; compressor description (e.g., compressor service purpose, compressor manufacturer name, model name, and/or model number); full load data (e.g., full demand power and full actual cubic feet per minute (ACFM)); actual electrical demand (e.g., percent of full power and actual power); actual air flow (percent of full flow and ACFM); load factor (the percent of time that the compressor operates fully-loaded, e.g., 75% load factor the compressor is full-loaded 75% of the time.)

FIG. 5 shows an example overview GUI (the GUI 500) included in a GUI operating panel display (e.g., display 552). Display 552 may include a display for the compressed air system hardware. For example, a compressor GUI (e.g., a compressor A GUI 551) for a first compressor (e.g., first standby compression generator 361) may include various system parameters, monitored parameters, and operational parameters such as pressure, temperature, and flowrate parameters. The display may also show limit alarm trips and program interlocks, e.g., permissives.

FIGS. 6-7 show various examples in accordance with one or more embodiments. FIG. 6 shows a GUI 600 for an automatic computer-controlled management system, where a command signal is sent from a control system (not shown) to a set of standby compression generators 630. The set of standby compression generators 630 includes quantity nine compression generators including a compressor 8A 601, compressor 8B 602, compressor 8C 603, compressor 8D 604, compressor 8E 605, compressor 8F 606, compressor 8G 607, compressor 8H 608, compressor 8J 609. Each of the compressors in the set of standby compression generators 630 may include a monitoring subsystem. For example, compressor 8A 601 may have a monitoring subsystem 616. After receiving the command signal, one or more of the monitoring subsystems (e.g., a monitoring subsystem 616) coupled to each of the standby compression generators (601, 602, 603, 604, 605 606, 607, 608, and 609) may start collecting standby compression generator data to generate a pressure log. FIG. 6 shows the monitoring subsystems monitoring operational parameters at various locations within a compressed air system.

FIG. 6 also shows two compressors selected for standby duty. These two compressors are therefore targeted standby compressors. For example, auto-start mode has been assigned to compressor J 609 (e.g., a compressor first standby selection 621). Auto-start mode has also been assigned to compressor H 608 (e.g., a compressor second standby selection 622). FIG. 6 shows that a third standby mode has not been assigned, i.e., auto-start mode remains unassigned to any compressor (e.g., a compressor third standby selection 623).

FIG. 7 shows a GUI 700 for three examples of compressor face plates. Faceplate 701 shows information about a compressor assigned to a first standby mode (e.g., a compressor first standby selection 721). Faceplate 702 shows information about a compressor assigned to a second standby mode (e.g., a compressor second standby selection 722). Faceplate 703 shows that no compressor has been assigned to a third standby mode (e.g., a compressor third standby selection table 723).

While FIGS. 1, 2, 3, 4A, 4B, 5, 6, 7, and 9 show various configurations of hardware components and/or software components, other configurations may be used without departing from the scope of the disclosure. For example, various components in FIGS. 1, 2, 3, 4A, 4B, 5, 6, 7, and 9 may be combined to create a single component. As another example, the functionality performed by a single component may be performed by two or more components.

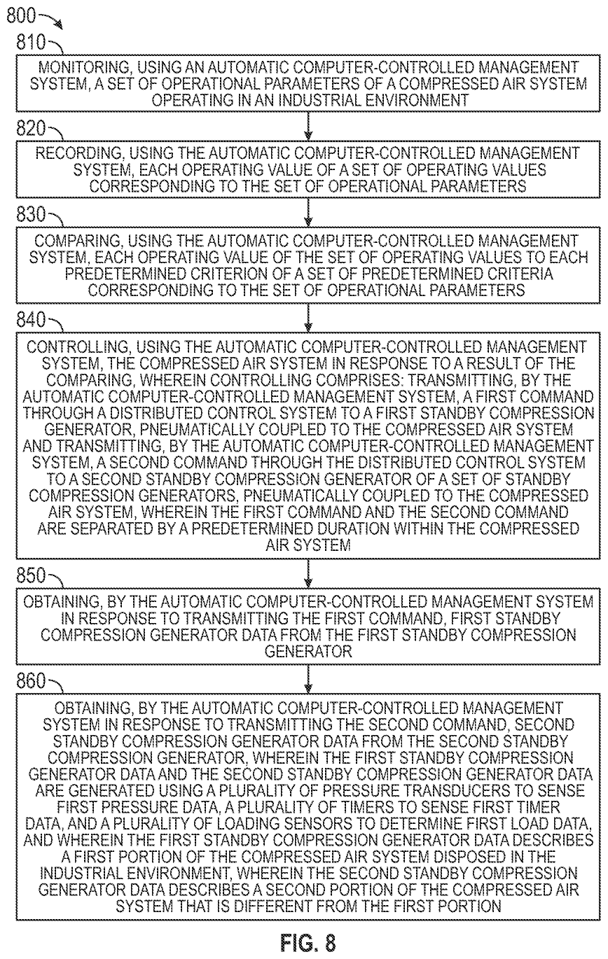

Turning to FIG. 8, FIG. 8 shows a flowchart in accordance with one or more embodiments. Specifically, FIG. 8 describes a general method (e.g., a method 800) using an automatic computer-controlled management system to control various compressed air systems in an industrial environment. One or more blocks in FIG. 8 may be performed by one or more components (e.g., system 300, DCS D 360, compressed air system D 365, and/or first standby compression generator 361) as described in FIGS. 1, 2, 3, 4A, 4B, 5, 6, 7, and 9. While the various blocks in FIG. 8 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

At step 810, an automatic computer-controlled management system (e.g., a system) monitors a set of operational parameters of a compressed air system operating in an industrial environment. For example, the system monitors a pressure within an instrument air pneumatic system operating in a gas plant.

At step 820, the automatic computer-controlled management system records each operating value of a set of operating values corresponding to the set of operational parameters. For example, the system records the pressure of a corresponding area of interest such as a pressure at a compressor outlet in the pneumatic system.

At step 830, the automatic computer-controlled management system compares each operating value of the set of operating values to each predetermined criterion of a set of predetermined criteria corresponding to the set of operational parameters. For example, the system records operating values such as pressure, run time duration, and percent loading. The system then compares each of those values with corresponding tolerances.

At step 840, the automatic computer-controlled management system controls the compressed air system in response to a result of the comparing. Controlling includes transmitting, by the automatic computer-controlled management system, a first command through a distributed control system to a first standby compression generator pneumatically coupled to the compressed air system. Controlling may also include transmitting, by the automatic computer-controlled management system, a second command through the distributed control system to a second standby compression generator of a set of standby compression generators pneumatically coupled to the compressed air system.

Staying with step 840, the first command and the second command may be separated by a predetermined duration within the compressed air system. For example, if the result of the comparing is that a first recorded pressure falls below a lower end of the tolerance for a first pressure, then the system may transmit a command to a first air compressor to turn on. If the result of the comparing is that a second recorded pressure falls below a lower end of a tolerance for a second pressure, then the system may transmit a command to a second air compressor to turn on. A predetermined duration of zero may result in the system sending a start command simultaneously to both the first air compressor and the second air compressor.

At step 850, the automatic computer-controlled management system obtains data in response to transmitting the first command. For example, the system may obtain first standby compression generator data from the first standby compression generator.

At step 860, the automatic computer-controlled management system obtains data in response to transmitting the second command. For example, the system may obtain second standby compression generator data from the second standby compression generator. The first standby compression generator data and the second standby compression generator data are generated using one or more of a pressure transducer, a run-time timer, and a loading sensor. The system may use a pressure transducer to sense first pressure data, a timer to sense first timer data, and a loading sensor to sense first load data.

Staying with step 860, the first standby compression generator data may describe a first section of the compressed air system disposed in the industrial environment. The second standby compression generator data may describe a second section of the compressed air system that is different from the first section. For example, in a gas plant, the first compressor and the second compressor may be separated from each other by a distance. The distance separating the first and second compressors may be large enough to cause pressure variations due to dynamic flow prior to pressure stabilization. The pressure variations may in turn be significant enough to affect the performance of the system and therefore the system may compensate for the pressure variations. in accordance with one or more embodiments the system may compensate for dynamic pressure variations by separating start commands by the predetermined duration. The start commands may be simultaneous if the system predetermines a separation of zero duration between start commands.

Embodiments may be implemented on a computer system. FIG. 9 is a block diagram of a computer system such as the computer 902 used to provide computational functionalities associated with described algorithms, methods, functions, processes, flows, and procedures as described in the instant disclosure, according to an implementation. The illustrated computer (e.g., computer 902) is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 902 may include a computer that includes an input device, such as a keypad, keyboard, touch screen, or other device that can accept user information, and an output device that conveys information associated with the operation of the computer 902, including digital data, visual, or audio information (or a combination of information), or a graphical user interface.

The computer 902 can serve in a role as a client, network component, a server, a database or other persistency, or any other component (or a combination of roles) of a computer system for performing the subject matter described in the instant disclosure. The illustrated computer (computer 902) is communicably coupled with a network 916. In some implementations, one or more components of the computer 902 may be configured to operate within environments, including cloud-computing-based, local, global, or other environment (or a combination of environments).

At a high level, the computer 902 is an electronic computing device operable to receive, transmit, process, store, or manage data and information associated with the described subject matter. According to some implementations, the computer 902 may also include or be communicably coupled with an application server, e-mail server, web server, caching server, streaming data server, business intelligence server, or other server (or a combination of servers).

The computer 902 can receive requests over network 916 from a client application (for example, executing on another computer 902) and responding to the received requests by processing the said requests in an appropriate software application. In addition, requests may also be sent to the computer 902 from internal users (for example, from a command console or by other appropriate access method), external or third-parties, other automated applications, as well as any other appropriate entities, individuals, systems, or computers.

Each of the components of the computer 902 can communicate using a system bus 904. In some implementations, any or all of the components of the computer 902, both hardware or software (or a combination of hardware and software), may interface with each other or the interface 906 (or a combination of both) over the system bus 904 using an application programming interface (an API 912) or a service layer 914 (or a combination of the API 912 and service layer 914. The API 912 may include specifications for routines, data structures, and object classes. The API 912 may be either computer-language independent or dependent and refer to a complete interface, a single function, or even a set of APIs. The service layer 914 provides software services to the computer 902 or other components (whether or not illustrated) that are communicably coupled to the computer 902. The functionality of the computer 902 may be accessible for all service consumers using this service layer. Software services, such as those provided by the service layer 914, provide reusable, defined business functionalities through a defined interface. For example, the interface may be software written in JAVA, C++, or other suitable language providing data in extensible markup language (XML) format or other suitable format. While illustrated as an integrated component of the computer 902, alternative implementations may illustrate the API 912 or the service layer 914 as stand-alone components in relation to other components of the computer 902 or other components (whether or not illustrated) that are communicably coupled to the computer 902. Moreover, any or all parts of the API 912 or the service layer 914 may be implemented as child or sub-modules of another software module, enterprise application, or hardware module without departing from the scope of this disclosure.

The computer 902 includes an interface 906. Although illustrated as a single one of interface 906 in FIG. 9, two or more of the interface 906 may be used according to particular needs, desires, or particular implementations of the computer 902. The interface 906 is used by the computer 902 for communicating with other systems in a distributed environment that are connected to the network 916. Generally, the interface 906 includes logic encoded in software or hardware (or a combination of software and hardware) and operable to communicate with the network 916. More specifically, the interface 906 may include software supporting one or more communication protocols associated with communications such that the network 916 or hardware of the interface is operable to communicate physical signals within and outside of the illustrated computer (computer 902).

The computer 902 includes at least one of a computer processor 918. Although illustrated as a single one of the computer processor 918 in FIG. 9, two or more processors may be used according to particular needs, desires, or particular implementations of the computer 902. Generally, the computer processor 918 executes instructions and manipulates data to perform the operations of the computer 902 and any algorithms, methods, functions, processes, flows, and procedures as described in the instant disclosure.

The computer 902 also includes a memory 908 that holds data for the computer 902 or other components (or a combination of both) that can be connected to the network 916. For example, memory 908 can be a database storing data consistent with this disclosure. Although illustrated as a single one of memory 908 in FIG. 9, two or more memories may be used according to particular needs, desires, or particular implementations of the computer 902 and the described functionality. While memory 908 is illustrated as an integral component of the computer 902, in alternative implementations, memory 908 can be external to the computer 902.

The application 910 is an algorithmic software engine providing functionality according to particular needs, desires, or particular implementations of the computer 902, particularly with respect to functionality described in this disclosure. For example, application 910 can serve as one or more components, modules, applications, etc. Further, although illustrated as a single one of application 910, the application 910 may be implemented as a multiple quantity of application 910 on the computer 902. In addition, although illustrated as integral to the computer 902, in alternative implementations, the application 910 can be external to the computer 902.

There may be any number of computers such as the computer 902 associated with, or external to, a computer system containing computer 902, each computer 902 communicating over network 916. Further, the term “client,” “user,” and other appropriate terminology may be used interchangeably as appropriate without departing from the scope of this disclosure. Moreover, this disclosure contemplates that many users may use one of computer 902, or that one user may use multiple computers such as computer 902.

In some embodiments, the computer 902 is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, a cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A system comprising:
an automatic computer-controlled management system disposed in an industrial environment;
a compressed air system disposed in the industrial environment;
a first standby compression generator pneumatically coupled to the compressed air system and coupled to the automatic computer-controlled management system, the first standby compression generator comprising:
a first pressure transducer,
a first timer,
a first loading sensor, wherein the first pressure transducer, the first timer, and the first loading sensor are configured to generate first standby compression generator data, and
a first communication interface;
a second standby compression generator of a set of standby compression generators pneumatically coupled to the compressed air system and coupled to the automatic computer-controlled management system, the second standby compression generator comprising:
a second pressure transducer,
a second timer,
a second loading sensor, wherein the second pressure transducer, the second timer, and the second loading sensor are configured to generate second standby compression generator data, and
a second communication interface; and
a data cable disposed in the industrial environment and coupled to the automatic computer-controlled management system, the first standby compression generator, and the second standby compression generator,
wherein the first standby compression generator is configured to transmit the first standby compression generator data to the automatic computer-controlled management system using the first communication interface, and
wherein the second standby compression generator is configured to transmit the second standby compression generator data to the automatic computer-controlled management system using the second communication interface, and
wherein the first standby compression generator and the second standby compression generator are separated by a predetermined distance within the compressed air system.

2. The system of claim 1,
wherein the first standby compression generator further comprises a processor, a memory, and a data cable connector configured to couple to the data cable, and
wherein the first standby compression generator is configured to receive, over the data cable, a request to acquire the first standby compression generator data, and
wherein the memory is configured to store the first standby compression generator data until the first standby compression generator data is transmitted to the automatic computer-controlled management system.

3. The system of claim 1,
wherein the first standby compression generator comprises a monitoring subsystem configured to transmit a first set of operating values of a first set of operational parameters of the first standby compression generator to the automatic computer-controlled management system.

4. The system of claim 1,
wherein the compressed air system comprises:
a header disposed in the compressed air system, and
a trim compressor, pneumatically coupled to the header, comprising a trim communication interface coupled to a trim data cable connector coupled to the data cable, and
wherein the automatic computer-controlled management system is configured to generate a pressure log of a compressed air pressure of interest within the compressed air system using the first standby compression generator data and the second standby compression generator data, and
wherein the first standby compression generator corresponds to a first section of the compressed air system and the second standby compression generator corresponds to a second section of the compressed air system.

5. The system of claim 1,
wherein the compressed air system is an instrument air supply.

6. The system of claim 1, further comprising:
a distributed control system disposed in the compressed air system, wherein the distributed control system is configured to:
transmit a first command from the automatic computer-controlled management system to the first communication interface;
transmit a second command from the automatic computer-controlled management system to the second communication interface;
transmit the first standby compression generator data to the automatic computer-controlled management system;
transmit the second standby compression generator data to the automatic computer-controlled management system, and
allow data transfer through the data cable from the compressed air system to the automatic computer-controlled management system.

7. The system of claim 1, wherein the automatic computer-controlled management system is configured to:
determine an air pressure of a predetermined section of the compressed air system using the first standby compression generator data and the second standby compression generator data;
determine whether the air pressure of the predetermined section satisfies a predetermined criterion; and
start, in response to determining that the predetermined section fails to satisfy the predetermined criterion, a pressurization operation of the compressed air system.

8. The system of claim 1, wherein the first standby compression generator is configured to:
obtain a command to generate the first standby compression generator data; and
generate, in response to obtaining the command, the first standby compression generator data using the first pressure transducer, the first timer, and the first loading sensor.

9. The system of claim 1, wherein the automatic computer-controlled management system is configured to:
transmit, over the data cable, a first command to the first standby compression generator;
transmit, over the data cable, a second command to the second standby compression generator, and
wherein the first standby compression generator data is generated in response to the first standby compression generator obtaining the first command, and
wherein the second standby compression generator data is generated in response to the second standby compression generator obtaining the second command.

10. The system of claim 1, further comprising:
a third standby compression generator in the set of standby compression generators pneumatically coupled to the compressed air system,
wherein the third standby compression generator comprises a third communication interface coupled to a third data cable connector,
wherein the third standby compression generator is coupled to the automatic computer-controlled management system, and
wherein the third standby compression generator receives a third command through the automatic computer-controlled management system to generate third standby compression generator data.

11. An apparatus, comprising:
a compression generator;
a monitoring subsystem;
a data cable connector configured to couple to a data cable;
a communication interface coupled to the data cable connector;
a processor coupled to the compression generator, the monitoring subsystem, and the communication interface; and
a memory coupled to the processor, wherein the memory comprises instructions configured to perform a method comprising:
obtain a command to generate standby compression generator data,
generate the standby compression generator data using the compression generator and the monitoring subsystem, and
transmit the standby compression generator data over the data cable using the communication interface.

12. The apparatus of claim 11,
wherein the compression generator is configured to compress air from a first pressure to a second pressure; and
wherein the monitoring subsystem is configured to detect an air pressure, record a time duration, and to sense a compressor loading.

13. The apparatus of claim 11, further comprising:
a processor coupled to the communication interface,
wherein the communication interface is configured to transmit the standby compression generator data regarding a compressed air pressure of interest to an automatic computer-controlled management system.

14. The apparatus of claim 11,
wherein the memory is configured to store the standby compression generator data.

15. The apparatus of claim 11,
wherein the method further comprises recording the standby compression generator data after the apparatus receives a command to start to determine the standby compression generator data;
wherein the method further comprises generating a pressure log using the standby compression generator data; and
wherein the method further comprises transmitting, using the data cable connected to the data cable connector, and the communication interface, the pressure log to an automatic computer-controlled management system.

16. A method comprising:
monitoring, using an automatic computer-controlled management system, a set of operational parameters of a compressed air system operating in an industrial environment;
recording, using the automatic computer-controlled management system, each operating value of a set of operating values corresponding to the set of operational parameters;
comparing, using the automatic computer-controlled management system, each operating value of the set of operating values to each predetermined criterion of a set of predetermined criteria corresponding to the set of operational parameters;
controlling, using the automatic computer-controlled management system, the compressed air system in response to a result of the comparing;
wherein controlling comprises:
transmitting, by the automatic computer-controlled management system, a first command through a distributed control system to a first standby compression generator, pneumatically coupled to the compressed air system; and
transmitting, by the automatic computer-controlled management system, a second command through the distributed control system to a second standby compression generator of a set of standby compression generators, pneumatically coupled to the compressed air system, wherein the first command and the second command are separated by a predetermined duration within the compressed air system;
obtaining, by the automatic computer-controlled management system in response to transmitting the first command, first standby compression generator data from the first standby compression generator; and
obtaining, by the automatic computer-controlled management system in response to transmitting the second command, second standby compression generator data from the second standby compression generator;
wherein the first standby compression generator data and the second standby compression generator data are generated using a plurality of pressure transducers to sense first pressure data, a plurality of timers to sense first timer data, and a plurality of loading sensors to determine first load data,
wherein the first standby compression generator data describes a first section of the compressed air system disposed in the industrial environment, and
wherein the second standby compression generator data describes a second section of the compressed air system that is different from the first section.

17. The method of claim 16, further comprising:
performing a compression simulation of the industrial environment of one or more compressed air systems for the first section of the compressed air system using the first standby compression generator data, the first pressure data, the first timer data, and the first load data; and
determining a predicted duty cycling array for the one or more compressed air systems using the compression simulation.

18. The method of claim 16, further comprising:
performing a compression simulation of the industrial environment of one or more compressed air systems for the second section of the compressed air system using the second standby compression generator data, second compressed pressure data, second timer data, and second load data; and
determining a predicted duty cycling array for the one or more compressed air systems using the compression simulation.

19. The method of claim 16,
wherein the automatic computer-controlled management system adjusts one or more operational parameters of a compression operation in the industrial environment based on the first standby compression generator data, the first pressure data, the first timer data, and the first load data, and/or compression simulations of the industrial environment of one or more compressed air systems at the first section of the compressed air system.

20. The method of claim 16, further comprising:
performing a compressor maintenance operation based on a compression simulation, using the first standby compression generator data, the first pressure data, the first timer data, and the first load data, at the first section of the compressed air system of one or more compressed air systems of the industrial environment.

21. The method of claim 16, further comprising:
performing a compressor maintenance operation based on a compression simulation, using the second standby compression generator data, second compressed pressure data, second timer data, and second load data, at the second section of the compressed air system of one or more compressed air systems of the industrial environment.

22. The method of claim 16,
wherein the monitoring comprises automatically receiving the set of operating values at the automatic computer-controlled management system transmitted through the distributed control system from a monitoring subsystem coupled to the automatic computer-controlled management system; and
in response to determining that the result of the comparing fails to meet the predetermined criterion, sending an alarm to a control panel of the automatic computer-controlled management system to alert a fault.

23. The method of claim 16 further comprising,
transmitting, by the automatic computer-controlled management system a third command through the distributed control system to a third standby compression generator; and
obtaining, by the automatic computer-controlled management system in response to transmitting the third command, third standby compression generator data from the third standby compression generator;
wherein the set of standby compression generators comprises three air compressors, and
wherein the transmitting the first command comprises a first activation command to the first standby compression generator, the transmitting the second command comprises a second activation command to the second standby compression generator, and transmitting the third command comprises a third activation command to the third standby compression generator; and
wherein the transmitting the first activation command, the second activation command, and the third activation command comprises a predetermined start sequence.

24. The method of claim 23,
wherein the automatic computer-controlled management system determines the predetermined start sequence using the first standby compression generator data, the second standby compression generator data, and the third standby compression generator data.

25. The method of claim 16 further comprising,
monitoring header pressure data of header pressure in a header disposed in the compressed air system and pneumatically coupled to the first standby compression generator and the second standby compression generator; and
trimming the header pressure using a trim compressor and the header pressure data pneumatically coupled to the compressed air system.
